(19) United States
(12) Patent Application Publication
(10) Pub. No.: US 2026/0058596 A1
(43) Pub. Date: Feb. 26, 2026

(54) DRIVE DEVICE

(71) Applicant: TOYOTA JIDOSHA KABUSHIKI KAISHA, Toyota-shi (JP)

(72) Inventor: Shohei OI, Okazaki-shi (JP)

(73) Assignee: TOYOTA JIDOSHA KABUSHIKI KAISHA, Toyota-shi (JP)

(21) Appl. No.: 19/073,500

(22) Filed: Mar. 7, 2025

(30) Foreign Application Priority Data
Aug. 20, 2024 (JP) 2024-139243

(51) Int. Cl. H02P 29/62; B60L 15/00; H02P 25/22

(52) U.S. Cl. CPC H02P 29/62; B60L 15/007; H02P 25/22; B60L 2240/545

(57) ABSTRACT

A drive device includes: an energy storage device; a motor including a three-phase coil; a first inverter including multiple first switching elements and connected to a power line to which the energy storage device is connected, and to a first end of the three-phase coil; a second inverter including multiple second switching elements and connected to the power line and a second end of the three-phase coil; a cooling device that cools the energy storage device, the motor, and the first and second inverters using a cooling medium; and a control device that controls the first and second inverters based on a torque command from the motor. The control device controls the first and second inverters such that all phase currents of three phases of the three-phase coil circulate from one of the first and second inverters to the three phases via the power line and the other inverter.

### CROSS-REFERENCE TO RELATED APPLICATION

This application claims priority to Japanese Patent Application No. 2024-139243 filed on Aug. 20, 2024. The disclosure of the above-identified application, including the specification, drawings, and claims, is incorporated by reference herein in its entirety.

### BACKGROUND

### 1. Technical Field

The present disclosure relates to drive devices.

### 2. Description of Related Art

A related drive device has been proposed that includes a motor (electric motor), an inverter, and a hydraulic mechanism (see, for example, Japanese Unexamined Patent Application Publication No. 2009-44805 (JP 2009-44805 A)). The motor includes two rotors. The hydraulic mechanism supplies hydraulic oil to a phase change mechanism provided in the rotors of the motor. In this device, when the temperature of the hydraulic oil is lower than a predetermined temperature, a stator coil of the motor is energized to heat the hydraulic oil. The phase can thus be changed more responsively at low temperatures.

### SUMMARY

Another drive device has also been proposed that includes an energy storage device, a motor including a three-phase coil, and first and second inverters. The first and second inverters are connected to a power line to which the energy storage device is connected. The first inverter is connected to a first end of the third-phase coil and includes a plurality of first switching elements. The second inverter is connected to a second end of the third-phase coil and includes a plurality of second switching elements. In the drive device in which the first and second inverters and the motor are connected in an H-bridge configuration as described above, it is desirable to increase the amount of heat that is created by the motor and the first and second inverters, in order to heat the energy storage device.

The present disclosure provides a drive device that creates a large amount of heat.

In order to achieve the above primary object, the drive device according to the present disclosure adopts the following measures.

A drive device according to a first aspect of the present disclosure is a drive device including:
an energy storage device;
a motor including a three-phase coil;
a first inverter including a plurality of first switching elements, connected to a power line to
which the energy storage device is connected, and connected to a first end of the three-phase coil;
a second inverter including a plurality of second switching elements, connected to the power line, and connected to a second end of the three-phase coil;
a cooling device configured to cool the energy storage device, the motor, the first inverter, and the second inverter using a cooling medium; and
a control device configured to control the first inverter and the second inverter based on a torque command from the motor.

The control device is configured to control the first inverter and the second inverter such that all phase currents of three phases of the three-phase coil of the motor circulate from one of the first inverter and the second inverter to the three phases via the power line and the other of the first inverter and the second inverter.

In the drive device of the present disclosure, the first inverter and the second inverter are controlled such that all of the phase currents of the three phases of the three-phase coil of the motor circulate from one of the first inverter and the second inverter to the three phases via the power line and the other of the first inverter and the second inverter. This configuration allows a larger amount of current to flow through the motor and the first and second inverters. As a result, a larger amount of heat can be created by the motor and the first and second inverters.

In the drive device according to the first aspect of the present disclosure, the control device may be configured to control the first inverter and the second inverter by feedback control such that each of the phase currents of the motor becomes a current that is based on a requested amount of heat requested to raise the temperature of the energy storage device. With this configuration, heat can be more appropriately created using the motor and the first and second inverters.

In the drive device according to the first aspect of the present disclosure, the control device may be configured to control the first inverter and the second inverter by feedback control such that a zero-phase current becomes a current that is based on a requested amount of heat requested to raise the temperature of the energy storage device. The zero-phase current is the sum of the phase currents of the motor. With this configuration, heat can be more appropriately created using the motor and the first and second inverters.

The drive device according to the first aspect of the present disclosure may further include

a load device attached to either or both of a positive line and a negative line of the power line. With this configuration, heat created by the load device can also be used in addition to heat created by the motor and the first and second inverters. Therefore, it is possible to create a larger amount of heat.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a schematic configuration diagram of a battery electric vehicle in which a drive device according to an embodiment of the present disclosure is mounted;

FIG. 2 is a block diagram illustrating exemplary functional blocks in the control of first and second inverters at low temperatures by an ECU;

FIG. 3 is a diagram illustrating an example of a current flow in a battery electric vehicle according to the embodiment;

FIG. 4 is a diagram illustrating the relationship between each phase current and a zero-phase current which is a sum of phase currents; and

FIG. 5 is a block diagram illustrating exemplary functional blocks in the control of the first and second inverters at low temperatures according to an ECU of another embodiment.

### DETAILED DESCRIPTION OF EMBODIMENTS

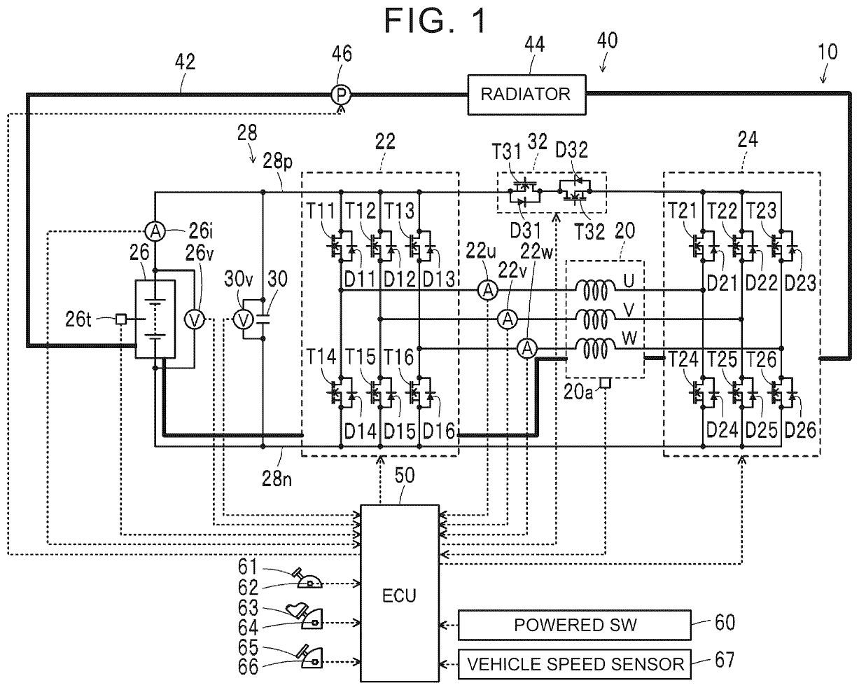

A mode (embodiment) for carrying out the present disclosure will be described with reference to the drawings. FIG. 1 is a schematic configuration diagram of a battery electric vehicle 10 in which a drive device according to an embodiment of the present disclosure is mounted. As shown in the figure, the battery electric vehicle 10 of the embodiment includes a motor 20 and first and second inverters 22, 24. The battery electric vehicle 10 of the embodiment further includes a battery 26 as an energy storage device, a switching device 32 as a load device, a cooling device 40, and an electronic control unit (hereinafter referred to as “ECU”) 50 as a control device.

The motor 20 is configured as a three-phase AC motor having, for example, a rotor in which a permanent magnet is embedded in a rotor core, and a stator in which a three-phase (U-phase, V-phase, and W-phase) coil is wound around the stator core. The rotor is connected to a drive shaft connected to the drive wheels via a differential gear.

The first and second inverters 22, 24 are connected to the power line 28 (positive line 28p and negative line 28n) to which the battery 26 is connected, and are respectively connected to a first end and a second end of the three-phase coil of the motor 20. The first inverter 22 includes six transistors (first switching elements) T11 to T16 as switching elements, and six diodes D11 to D16 connected in parallel to the six transistors T11 to T16. The transistors T11 to T16 are arranged in pairs so as to be on the source side and the sink side with respect to the positive line 28p and the negative line 28n, respectively. Each of the connection points of sets of two transistors, namely each of the connection points of the pairs of transistors T11 to T16, is connected to the first end of the three-phase coil of the motor 20. Like the first inverter 22, the second inverter 24 includes six transistors (second switching elements) T21 to T26 as switching elements, and six diodes D21 to D26. The transistors T21 to T26 are arranged in pairs so as to be on the source side and the sink side with respect to the positive line 28p and the negative line 28n, respectively. Each of the connection points of sets of two transistors, namely each of the connection points of the pairs of transistors T21 to T26, is connected to the second end of the three-phase coil of the motor 20. The battery 26 is configured as, for example, a lithium-ion secondary battery or a nickel-hydrogen secondary battery, and is connected to the power line 28 (positive line 28p and negative line 28n). A smoothing capacitor 30 is connected to the power line 28. In the embodiment, the battery 26, the capacitor 30, the first inverter 22, and the second inverter 24 are connected in this order in the power line 28.

The switching device 32 is attached to the positive line 28p of the power line 28. The switching device 32 includes two transistors T31, T32 and two diode D31, D32. The transistors T31, T32 are mounted in series with the positive line 28p. The diode D31 is connected in parallel to the transistor T31 such that the direction from the first inverter 22 to the second inverter 24 is the forward direction. The diode D32 is connected in parallel to the transistor T32 such that the direction from the second inverter 24 to the first inverter 22 is the forward direction.

The cooling device 40 includes a circulation channel 42, a radiator 44, and an electric pump 46. The circulation channel 42 is configured as a channel for circulating a cooling medium such as coolant to the battery 26, the first inverter 22, the motor 20, the second inverter 24, and the radiator 44 in this order. The electric pump 46 circulates the cooling medium in the circulation channel 42. The circulation channel 42 may be configured as a channel for circulating the cooling medium to the second inverter 24, the motor 20, the first inverter 22, the battery 26, and the radiator 44 in this order.

The ECU 50 includes a microcomputer having a CPU, a ROM, a RAM, a flash memory, an input and output port, and a communication port, various drive circuits, and various logic ICs. The ECU 50 receives signals from various sensors. Examples of the signals that are input include the rotational position θm from the rotational position sensor 20a for detecting the rotational position of the rotor of the motor 20 and the phase currents Iu, Iv, Iw of each phase of the motor 20 from the current sensors 22u, 22v, 22w for detecting the phase current of each phase of the motor 20. Other examples of the signals that are input include a voltage Vb of the battery 26 from the voltage sensor 26v, a current Ib of the battery 26 from the current sensor 26i, a temperature Tb of the battery 26 from the temperature sensor 26t, and a voltage VH of the capacitor 30 (power line 28) from the voltage sensor 30v. The inputted signals are, for example, an on-off signal from the power switch 60, an operating position (shift position SP) of the shift lever 61 from the shift position sensor 62, a depression amount (accelerator operation amount Acc) of the accelerator pedal 63 from the accelerator pedal position sensor 64, a depression amount (brake pedal position BP) of the brake pedal 65 from the brake pedal position sensor 66, and a vehicle speed V from the vehicle speed sensor 67. A switching control signal for the transistors T11 to T16, T21 to T26 of the first and second inverters 22, 24 and a switching control signal for the transistors T31, T32 of the switching device 32 are output from the ECU 50. The ECU 50 calculates the electrical angle θe and the rotational speed Nm of the motor 20 based on the rotational position θm of the rotor of the motor 20, and calculates the state of charge SOC of the battery 26 based on the integrated value of the current Ib of the battery 26.

In the battery electric vehicle 10 of the embodiment, the ECU 50 sets requested torque Td* requested for traveling, based on the accelerator operation amount Acc and the vehicle speed V. The ECU 50 also sets the torque command Tm* of the motor 20 so as to achieve traveling according to the set requested torque Td*, and performs switching control of the transistors T11 to T16, T21 to T26 of the first and second inverters 22, 24 based on the set torque command Tm*.

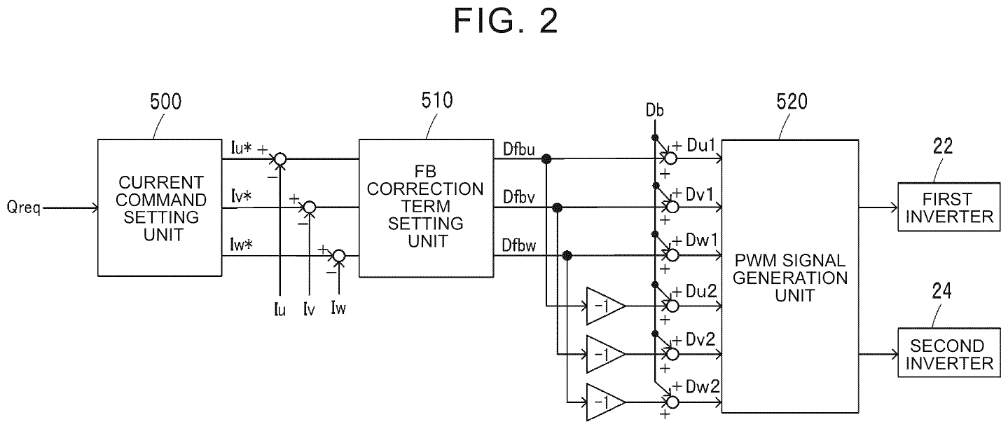

Next, the operation of the battery electric vehicle 10, in particular, the control of the first and second inverters 22, 24 at low temperatures will be described. FIG. 2 is a block diagram illustrating exemplary functional blocks in the control of the first and second inverters 22, 24 at low temperatures by the ECU 50. The ECU 50 includes a current command setting unit 500, a feedback (FB) correction term setting unit 510, and a PWM signal generation unit 520 as the functional blocks of FIG. 2. Here, the “low temperatures” may be such temperatures that the outside air temperature is equal to or lower than a predetermined temperature (e.g., 1° C., 3° C., or 5° C.), or temperatures that are too low for the battery 26 to perform its function. It is assumed that the transistors T31, T32 of the switching device 32 is on and the battery electric vehicle 10 is stopped.

The current command setting unit 500 sets the current commands Iu*, Iv*, Iw* of the motor 20 based on the requested amount of heat Qreq requested to raise the temperature of the battery 26, and outputs the set current commands Iu*, Iv*, Iw*. The ECU 50 determines in advance by experiments, analysis, machine learning, etc. the relationship between the requested amount of heat Qreq and the difference between the current temperature Tb of the battery 26 from the temperature sensor 26t and the lower limit temperature of the temperature range in which the battery 26 can exert its performance, and stores the determined relationship in the ROM. The requested amount of heat Qreq is set based on this relationship and the difference between the temperature Tb of the battery 26 from the temperature sensor 26t and the lower limit temperature of the temperature range in which the battery 26 can exhibit its performance. The current command setting unit 500 is set such that the current commands Iu*, Iv*, Iw* becomes the same amount of current in the same direction and becomes larger than the maximum current Immax allowed for the motor 20 and the maximum current Iinvmax allowed for the first and second inverters 22, 24 when the requested amount of heat Qreq is large.

The difference between the current commands Iu*, Iv*, Iw* and the phase currents Iu, Iv, Iw of each phase of the motor 20 from the current sensors 22u, 22v, 22w is inputted to FB correction term setting unit 510. The FB correction term setting unit 510 sets the feedback correction terms Dfbu, Dfbv, Dfbw of the duty command D* for canceling the difference between the current commands Iu*, Iv*, Iw* and the phase currents Iu, Iv, Iw. The FB correction term setting unit 510 outputs the set feedback correction terms Dfbu, Dfbv, Dfbw. Here, the duty command D* is a ratio of the on-time of each transistor in one cycle (the sum of the on-time and the off-time of each transistor).

Duty commands Du1*, Dv1*, Dw1* of the first inverter 22 obtained by adding feedback correction terms Dfbu, Dfbv, Dfbw to a predetermined fundamental value Db of the duty command D* and duty commands Du2*, Dv2*, Dw2* of the second inverter 24 obtained by adding the feedback correction terms Dfbu, Dfbv, Dfbw multiplied by the value of −1 to the fundamental value Db (e.g., 50%) are input to the PWM signal generation unit 520. The PWM signal generation unit 520 generates a PWM signal for switching the transistors T11 to T16, T21 to T26 of the first and second inverters 22, 24 by comparing the duty commands Du1*, Dv1*, Dw1*, Du2*, Dv2*, Dw2* with a triangular wave (carrier wave). The PWM signal generation unit 520 outputs the generated PWM signal to the first and second inverters 22, 24, and performs switching control of the transistors T11 to T16, T21 to T26 of the first and second inverters 22, 24. By such control, the first and second inverters 22, 24 are controlled by feedback control such that the phase currents Iu, Iv, Iw of each phase of the motor 20 become a current that is based on the requested amount of heat Qreq.

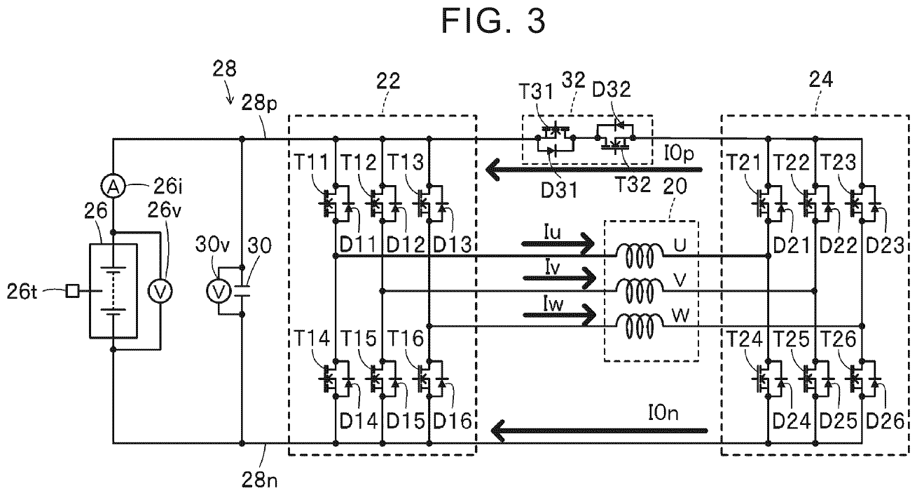

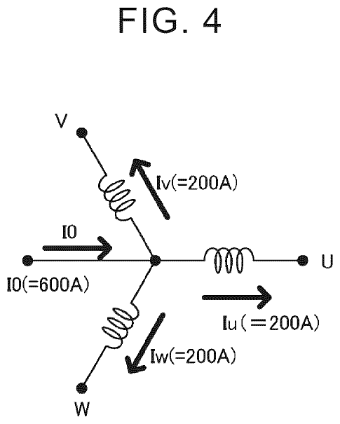

FIG. 3 is an explanatory diagram illustrating an example of the current flow in the battery electric vehicle 10 according to the embodiment. FIG. 4 is an explanatory diagram for explaining the relation between the phase currents Iu, Iv, Iw and the zero-phase current I0 (=Iu+Iv+Iw) that is the sum of the phase currents Iu, Iv, Iw. In FIGS. 3 and 4, thick arrows indicate the direction of the current. In battery electric vehicle 10 of the embodiment, the first and second inverters 22, 24 are controlled such that the phase currents Iu, Iv, Iw of each phase of the motor 20 flow from the first inverter 22 toward the second inverter 24. In addition, in the battery electric vehicle 10 of the embodiment, the first and second inverters 22, 24 are controlled such that the phase currents Iu, Iv, Iw of each phase of the motor 20 have the same current. With such control, as shown in FIG. 3, the current flows from each phase of the motor 20 to the positive line 28p and the negative line 28n of the power line 28 via the second inverter 24, and circulates to each phase via the first inverter 22. Therefore, as shown in FIG. 4, when the phase currents Iu, Iv, Iw are 200 A, the zero-phase current I0 is 600 A. The phase currents Iu, Iv, Iw can be increased according to the requested amount of heat Qreq as long as they are not larger than the maximum allowable current Immax for the motor 20 and the maximum allowable current Iinvmax for the first and second inverters 22, 24. Therefore, a larger amount of heat can be created by the motor 20, the first and second inverters 22, 24, and the switching device 32. Accordingly, the temperature of the cooling medium of the cooling device 40 can be accelerated, and the temperature of the battery 26 can be accelerated. Degradation of the battery 26 due to the low temperature can thus be more appropriately reduced.

In battery electric vehicle 10 in which the drive device of the above-described embodiment is mounted, the first and second inverters 22, 24 are controlled such that all the phase currents Iu, Iv, Iw of the three phases of the three-phase coil of the motor 20 circulate from the first inverter 22 to the three phases via the power line 28 and the second inverter 24. Therefore, a larger amount of heat can be created by the motor 20 and the first and second inverters 22, 24.

The first and second inverters 22, 24 are controlled by feedback control such that the phase currents Iu, Iv, Iw of the motor 20 becomes a current that is based on the requested amount of heat Qreq requested to raise the temperature of the battery 26. Accordingly, heat can be more appropriately created using the motor 20 and the first and second inverters 22, 24.

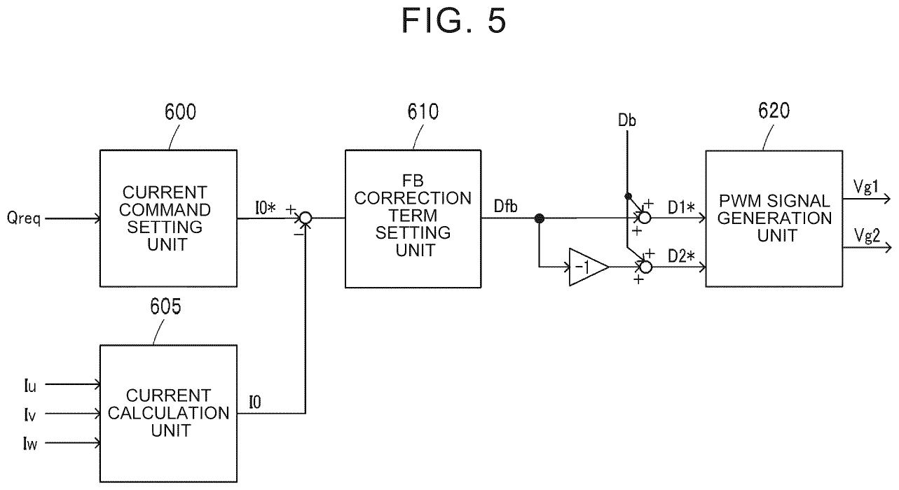

In the above embodiment, the first and second inverters 22, 24 are controlled by feedback control such that the phase currents Iu, Iv, Iw of each phase of the motor 20 becomes a current that is based on the requested amount of heat Qreq. However, as in other embodiments described below, the first and second inverters 22, 24 may be controlled by feedback control such that the zero-phase current I0 becomes a current that is based on the requested amount of heat Qreq. FIG. 5 is a block diagram illustrating exemplary functional blocks in the control of the first and second inverters 22, 24 at low temperature according to the ECU 50 of another embodiment. The ECU 50 includes a current command setting unit 600, a current calculation unit 605, a feedback (FB) correction term setting unit 610, and a PWM signal generation unit 620 as functional blocks of FIG. 5. This routine is executed when the vehicle is at a stop at a low temperature at which the outside air temperature is equal to or lower than a predetermined temperature (for example, 1° C., 3° C., or 5° C.). Here, the transistors T31, T32 of the switching device 32 are on.

The current command setting unit 600 sets the current command I0* of the zero-phase current I0 based on the requested amount of heat Qreq described above, and outputs the set current command I0*. The current command setting unit 600 sets the current command I0* to be larger when the requested amount of heat Qreq is large than when it is small.

The current calculation unit 605 receives the phase currents Iu, Iv, Iw of each phase of the motor 20 from the current sensors 22u, 22v, 22w, calculates a zero-phase current I0(=Iu+Iv+Iw) as the sum of the phase currents Iu, Iv, Iw, and outputs the calculated zero-phase current I0.

FB correction term setting unit 610 receives the difference between the current command I0* and the zero-phase current I0, sets the feedback correction term Dfb of the duty command for canceling the difference between the current command I0* and the zero-phase current I0, and outputs the set feedback correction term Dfb.

The PWM signal generation unit 620 generates a PWM signal for switching the transistors T11 to T16 of the first inverter 22 by comparing the duty command D1* of the first inverter 22 obtained by adding the feedback correction term Dfb to the fundamental value Db with a triangular wave (carrier wave). Then, the PWM signal generation unit 620 outputs the generated PWM signal to the first inverter 22, and performs switching control of the transistors T11 to T16 of the first inverter 22. The PWM signal generation unit 620 generates a PWM signal for switching the transistors T21 to T26 of the second inverter 24 by comparing the duty command D2* of the second inverter 24 obtained by subtracting the feedback correction term Dfb from the fundamental value Db with a triangular wave (carrier wave). The PWM signal generation unit 620 then outputs the generated PWM signal to the second inverter 24, and performs switching control of the transistors T21 to T26 of the second inverter 24. By such control, the first and second inverters 22, 24 are controlled by feedback control such that the zero-phase current I0 becomes a current that is based on the requested amount of heat Qreq. In this way, the current of the motor 20 can be made to be the same as the current illustrated in FIG. 3, and a larger amount of heat can be created. Degradation of the battery 26 due to the low temperature can thus be more appropriately reduced.

In the above embodiment, the first and second inverters 22, 24 are controlled by feedback control such that the phase currents Iu, Iv, Iw of the motor 20 becomes a current that is based on the requested amount of heat Qreq requested to raise the temperature of the battery 26. However, the duty commands Du1*, Dv1*, Dw1*, Du2*, Dv2*, Dw2* of the first and second inverters 22, 24 may be set based on the requested amount of heat Qreq, a PWM signal for switching the transistors T11 to T16, T21 to T26 of the first and second inverters 22, 24 may be generated by comparing the set duty commands Du1*, Dv1*, Dw1*, Du2*, Dv2*, Dw2* with the triangular wave (carrier wave), and the first and second inverters 22, 24 may be controlled by the generated PWM signal by feedforward control.

In the above embodiment, the first and second inverters 22, 24 are controlled such that all of the phase currents Iu, Iv, Iw of the three phases of the three-phase coil of the motor 20 circulate from the first inverter 22 to the three phases via the power line 28 and the second inverter 24. However, the first and second inverters 22, 24 may be controlled such that the phase currents Iu, Iv, Iw circulate from the second inverter 24 to the three phases via the power line 28 and the first inverter 22.

In the above embodiment, the switching device 32 is provided on the positive line 28p of the power line 28. However, the switching device 32 may be provided on the negative line 28n of the power line 28, the switching device 32 may be provided in each of the positive line 28p and the negative line 28n of the power line 28, or the switching device 32 may not be provided.

In the above embodiment, the drive device is mounted on battery electric vehicle 10 including the motor 20, but the present disclosure is not limited thereto. For example, the drive device may be mounted on a hybrid electric vehicle including a motor in addition to the motor. Further, for example, a drive device mounted on a fuel cell electric vehicle including a fuel-cell in addition to a motor may be used. The drive device may be mounted on a moving object other than the vehicle, a construction facility that does not move, or the like.

The correspondence between the main elements of the embodiments and the main elements of the disclosure described in the section of the means for solving the problem will be described. In the embodiment, the battery 26 corresponds to the “energy storage device,” the motor 20 corresponds to the “motor,” the first and second inverters 22, 24 correspond to the “first and second inverters,” the cooling device 40 corresponds to the “cooling device,” and the ECU 50 corresponds to the “control device.”

Note that the correspondence between the main elements of the embodiment and the main elements of the disclosure described in the section of the means for solving the problem is an example for specifically explaining the embodiment of the disclosure described in the section of the means for solving the problem, and therefore the elements of the disclosure described in the section of the means for solving the problem are not limited. That is, the interpretation of the disclosure described in the section of the means for solving the problem should be performed based on the description in the section, and the embodiments are only specific examples of the disclosure described in the section of the means for solving the problem.

Hereinafter, while embodiments for carrying out the present disclosure are described by using embodiments, it is needless to say that the present disclosure is not limited to such embodiments, and can be implemented in various forms without departing from the gist of the present disclosure.

The present disclosure is applicable to the manufacturing industry of drive devices etc.

What is claimed is:

1. A drive device including:
an energy storage device;
a motor including a three-phase coil;
a first inverter including a plurality of first switching elements, the first inverter being connected to a power line to which the energy storage device is connected and being connected to a first end of the three-phase coil;
a second inverter including a plurality of second switching elements, the second inverter being connected to the power line and connected to a second end of the three-phase coil;
a cooling device configured to cool the energy storage device, the motor, the first inverter, and the second inverter using a cooling medium; and
a control device configured to control the first inverter and the second inverter based on a torque command from the motor,
wherein the control device is configured to control the first inverter and the second inverter such that all phase currents of three phases of the three-phase coil of the motor circulate from one of the first inverter and the second inverter to the three phases via the power line and the other of the first inverter and the second inverter.

2. The drive device according to claim 1, wherein the control device is configured to control the first inverter and the second inverter by feedback control such that each of the phase currents of the motor becomes a current that is based on a requested amount of heat requested to raise a temperature of the energy storage device.

3. The drive device according to claim 1, wherein the control device is configured to control the first inverter and the second inverter by feedback control such that a zero-phase current becomes a current that is based on a requested amount of heat requested to raise a temperature of the energy storage device, the zero-phase current being a sum of the phase currents of the motor.

4. The drive device according to claim 1, further comprising a load device attached to either or both of a positive line and a negative line of the power line.
